(19) United States
(12) Patent Application Publication
(10) Pub. No.: US 2026/0252850 A1
(43) Pub. Date: Aug. 27, 2026

(54) TRANSFORMER-BASED CLUSTERING

(71) Applicant: International Business Machines Corporation, Armonk, NY (US)

(72) Inventors: Charlotte Isabella Sinclair PARK, Cambridge, MA (US); Parikshit RAM, Atlanta, GA (US); Kenneth Lee CLARKSON, Madison, NJ (US); Lior HORESH, North Salem, NY (US)

(21) Appl. No.: 19/065,893

(22) Filed: Feb. 27, 2025

(51) Int. Cl. G06N 3/0455; G06F 18/23213

(52) U.S. Cl. CPC G06N 3/0455; G06F 18/23213

(57) ABSTRACT

In some implementations, a device may input data points and cluster centers as token embeddings into a transformer architecture configured with k-means clustering for an encoder and a decoder. The device may perform a forward pass through the transformer architecture that uses a self-attention mechanism and a cross-attention mechanism to update cluster assignments for the data points and to update the cluster centers. The device may output the updated cluster assignments for the data points and the updated cluster centers from the transformer architecture.

### BACKGROUND

This disclosure relates to data analysis, and more specifically, to clustering. Clustering may include k-means clustering, which involves unsupervised machine learning to group or cluster data points into a specified number k of clusters based on their similarity. Clustering is used to identify patterns by grouping similar data points together. Discrete k-center clustering may be used for data analysis, data compression, and indexing.

### SUMMARY

Some aspects described herein relate to a computer-implemented method. The computer-implemented method may include inputting, by a processor set, data points and cluster centers as token embeddings into a transformer architecture configured with k-means clustering for an encoder and a decoder. The computer-implemented method may include performing, by a processor set, a forward pass through the transformer architecture that uses a self-attention mechanism and a cross-attention mechanism to update cluster assignments for the data points and to update the cluster centers. The computer-implemented method may include outputting, by a processor set, the updated cluster assignments for the data points and the updated cluster centers from the transformer architecture.

Some aspects described herein relate to a computer system. The computer system may include a processor set, one or more computer-readable storage media, and program instructions stored on the one or more computer-readable storage media to cause the processor set to perform operations. The operations may include generating data token embeddings for data points with cluster assignments and center token embeddings for cluster centers. The operations may include setting up an encoder-decoder transformer with the data token embeddings and the center token embeddings as input. The operations may include performing a forward pass through the encoder-decoder transformer to update the cluster assignments and the cluster centers. The operations may include extracting final cluster assignments and final cluster centers after the forward pass. The operations may include outputting the final cluster assignments and the final cluster centers.

Some aspects described herein relate to a computer program product. The computer program product may include one or more computer-readable storage media and program instructions stored on the one or more computer-readable storage media to perform operations. The operations may include configuring a transformer architecture to perform discrete clustering of input data points. The operations may include setting weights of the transformer architecture to mimic a Lloyd's algorithm for k-means clustering. The operations may include performing a forward pass through the transformer architecture using the input data points and cluster centers as input. The operations may include updating cluster assignments for the input data points based on an output of the transformer architecture. The operations may include outputting final cluster assignments and final cluster centers for the input data points from the output of the transformer architecture.

### BRIEF DESCRIPTION OF THE DRAWINGS

FIG. 1 is a diagram of an example computing environment for transformer-based clustering described herein.

FIG. 2 shows an example of clustering using a transformer-based architecture that utilizes self-attention and cross-attention.

FIGS. 3A-3C are diagrams illustrating an example implementation associated with self-attention in general encoder-decoder transformers and back propagation of discrete clustering to allow discrete clustering in a single forward pass.

FIG. 4 illustrates a diagram of using a large language model for setting up the clustering.

FIG. 5 illustrates a diagram of self-attention and cross-attention.

FIG. 6 is a diagram of clustering.

FIG. 7 shows a reset using self-attention and assignment using cross-attention.

FIG. 8 is a flowchart of an example process associated with transformer-based clustering.

FIG. 9 is a flowchart of an example process associated with transformer-based clustering.

FIG. 10 is a flowchart of an example process associated with transformer-based clustering.

### DETAILED DESCRIPTION

The following detailed description of example implementations refers to the accompanying drawings. The same reference numbers in different drawings may identify the same or similar elements.

Discrete k-center clustering is a widely applicable technique in data analysis, data compression, and indexing. The goal is to partition a given set of samples into k clusters, each represented by a prototype or center, where each sample belongs to only one cluster. Hard k-means is a standard version of k-means clustering, where each data point is assigned to exactly one cluster. Soft k-means is a version of k-means clustering that allows for fuzzy cluster assignments, where each data point can belong to multiple clusters with different membership probabilities. K-means clustering can be used, for example, to segment images into different regions based on their color and texture features or to identify patterns in gene expression data.

A popular algorithm for k-means clustering is Lloyd's algorithm. Lloyd's algorithm is a type of unsupervised machine learning algorithm. Lloyd's algorithm starts by randomly initializing k cluster centers, which are typically chosen from input data points. Each data point is assigned to the cluster with the closest center (e.g., using a Euclidean distance metric). The center of each cluster is updated to be the mean of all of the data points assigned to that cluster. The algorithm iterates between the assignment step and the update step until reaching convergence, which is typically achieved when the cluster centers no longer change significantly between iterations. However, Lloyd's algorithm is a combinatorial algorithm that cannot be differentiated through, making it difficult to incorporate into a deep learning pipeline where gradients need to be propagated through the clustering process. This limits the use of Lloyd's algorithm in applications where clustering is a key component of the overall model.

A transformer-based architecture is a neural network architecture that uses a transformer model as its primary building block. Some implementations described herein provide a transformer-based architecture for discrete k-center clustering. For example, a device configured with an encoder-decoder transformer architecture may take input data points and cluster centers as token embeddings into a transformer architecture configured with k-means clustering for an encoder and a decoder. Token embeddings, also known as token representations, are vectors that represent individual tokens in a sequence and are used as inputs to the transformer model. The device may perform a forward pass through the transformer architecture that uses a self-attention mechanism and a cross-attention mechanism to update cluster assignments for the data points and to update the cluster centers, and output the updated cluster assignments for the data points and the updated cluster centers from the transformer architecture.

Self-attention is a mechanism that enables a model to attend to different parts of the input data, such as text or images, and compute a weighted sum of the input elements. The weights are learned during training and reflect the relative importance of each input element. Cross-attention is a mechanism that enables a model to attend to different parts of two or more input sequences, such as text or images, and compute a weighted sum of the input elements. The weights are learned during training and reflect the relative importance of each input element, as well as the relationships between the different input sequences. Such mechanisms involve a query element (the input sequence that is being processed), a key element (the input sequence that is being attended to), and a value element (for computing a weighted sum). The cross-attention mechanism computes the weighted sum of the value elements based on the similarity between the query elements and the key elements. The similarity may be measured using a dot product or a scaled dot product.

In some aspects, the transformer architecture may use a weight configuration that mimics Lloyd's algorithm for the k-means clustering in the forward pass. The weights of the weight configuration may be configured to mimic Lloyd's algorithm by using a specific set of weight matrices that implement the k-means clustering algorithm. The weight matrices may include a query weight matrix Q (used to compute query vectors that are used to compute the attention weights), a key weight matrix K (used to compute key vectors that are used to compute the attention weights), and a value weight matrix V (used to compute value vectors that are used to compute the output of the transformer). To configure the weights to mimic Lloyd's algorithm, the device may set the weight matrices such that they implement the k-means clustering algorithm. This may include setting Q to compute cluster centers, K to compute distances between input data points and the cluster centers, and V to compute assignments of the input data points to the clusters.

In some aspects, the device may utilize a limiting version of a soft-max operation with a sufficiently low temperature parameter. The soft-max operation is a mathematical function that takes as input a set of real numbers and outputs a probability distribution over those numbers. The soft-max operation is commonly used in machine learning models to normalize the output of a neural network, ensuring that the output values are between 0 and 1 and add up to 1. A limiting version of the soft-max operation is a modification of the standard soft-max operation that uses a temperature parameter to control the output, or scale the input values before applying an exponential function. When the temperature parameter is sufficiently low, the output of the limiting version of the soft-max operation becomes a hard-max operation, where the output is a one-hot vector (i.e., a vector with a single 1 and all other elements 0). This is because the exponential function becomes very sensitive to the input values when the temperature parameter is small, and the largest input value dominates the output. In practice, a sufficiently low temperature parameter is typically achieved by setting the temperature parameter to a small value, such as 0.1 or 0.01. This causes the output of the soft-max operation to become more extreme, with the largest input value dominating the output.

By using a transformer-based architecture for k-means clustering, the device reduces computational overhead associated with traditional clustering methods, which often require separate, manually-configured post-processing steps to assign cluster labels. Additionally, the end-to-end differentiable nature of the transformer-based architecture enables the clustering process to be optimized in conjunction with other components of the deep learning pipeline, reducing the need for redundant computations and improving overall model efficiency. Furthermore, the transformer-based architecture may conserve processing resources, memory resources, network resources, and/or the like, by eliminating the need for multiple, separate computations to perform clustering and other tasks, reducing the energy consumption and thermal output of computing systems, and/or the like.

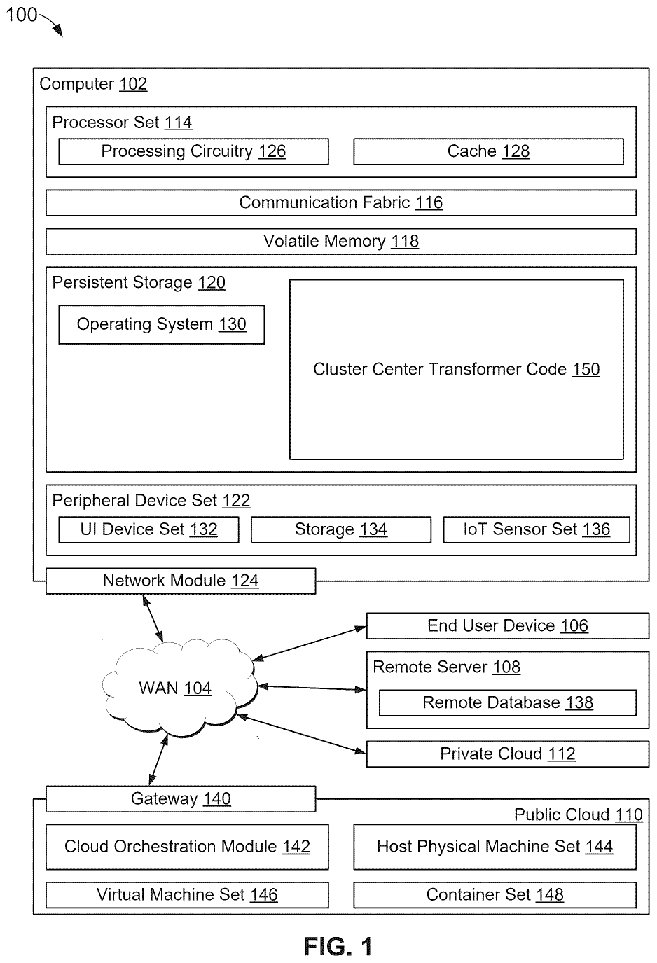

FIG. 1 is a diagram of an example computing environment 100 for transformer-based clustering described herein.

Computing environment 100 contains an example of an environment for the execution of at least some of the computer code involved in performing the inventive methods, such as cluster center transformer code 150. In addition to cluster center transformer code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and cluster center transformer code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in cluster center transformer code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

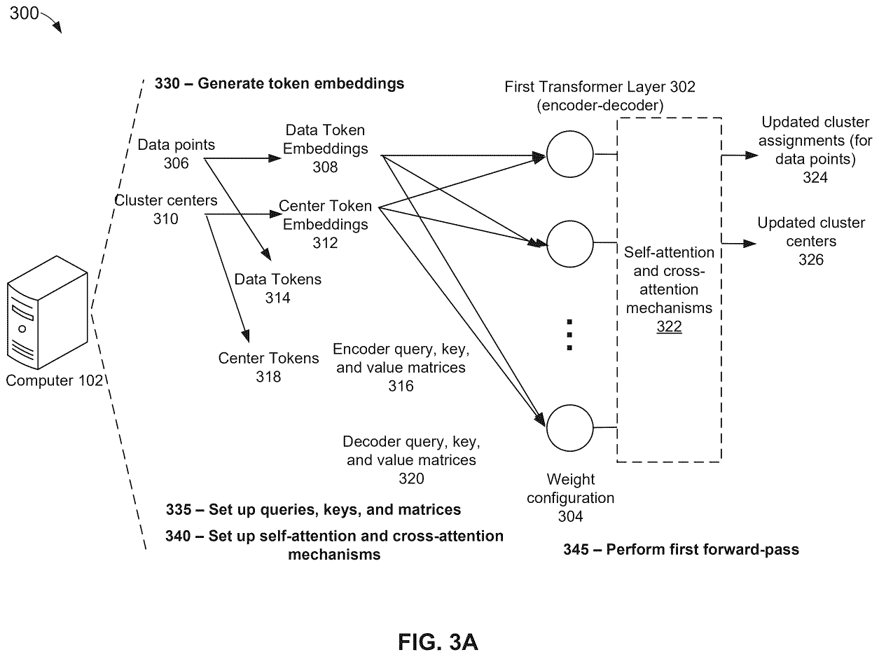

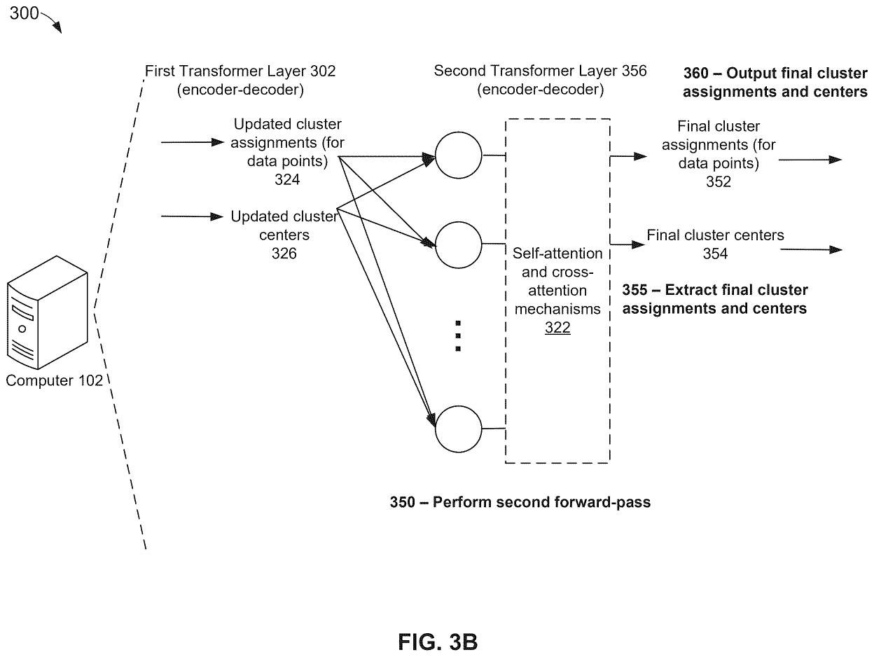

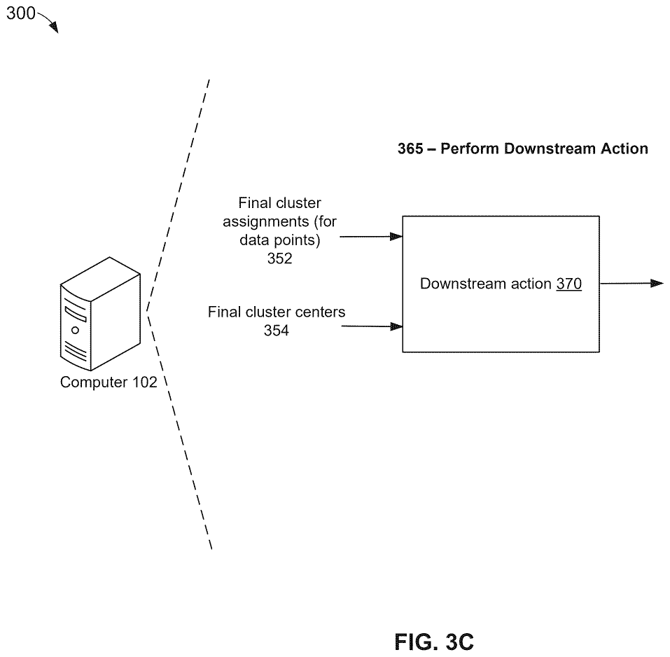

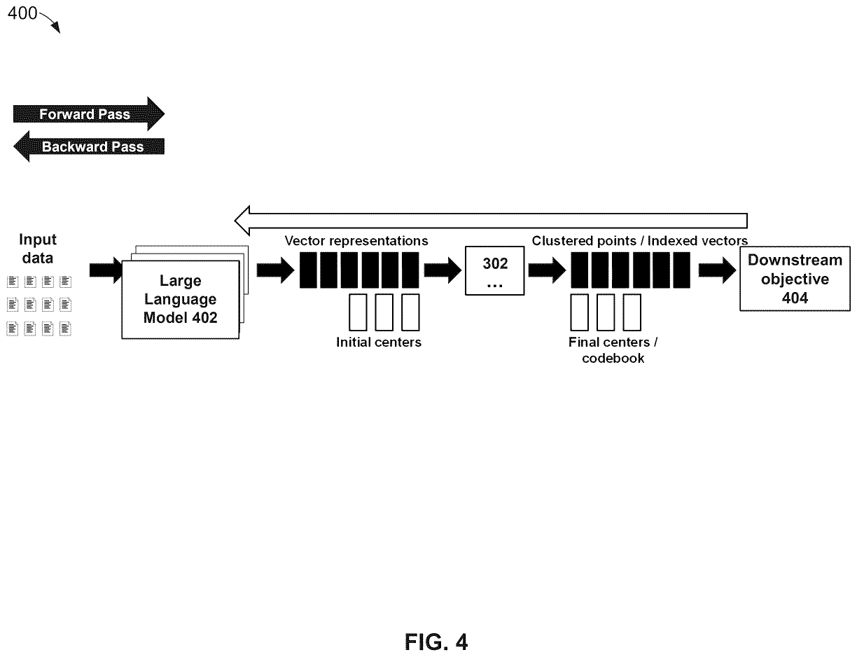

The code included in the cluster center transformer code 150 typically includes at least some of the computer code involved in performing one or more operations described herein, such as the operations of process 300 in FIGS. 3A-3C and the processes described in FIGS. 4-6.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

End user device (EUD) 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of virtualized computing environments (VCEs) will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some implementations, a device (e.g., computer 102, computer system) may cluster data points into k clusters using a transformer-based architecture. The transformer-based architecture may be configured with weights to mimic or emulate Lloyd's algorithm, such that a forward-pass through a single transformer layer almost exactly performs a single step of the Lloyd's algorithm for k-means clustering, thereby converting the discrete Lloyd's algorithm into multiple layers of encoder-decoder transformers. The device may cluster data the same as performing a forward-pass with the data (after appropriate modifications) through multiple transformer layers.

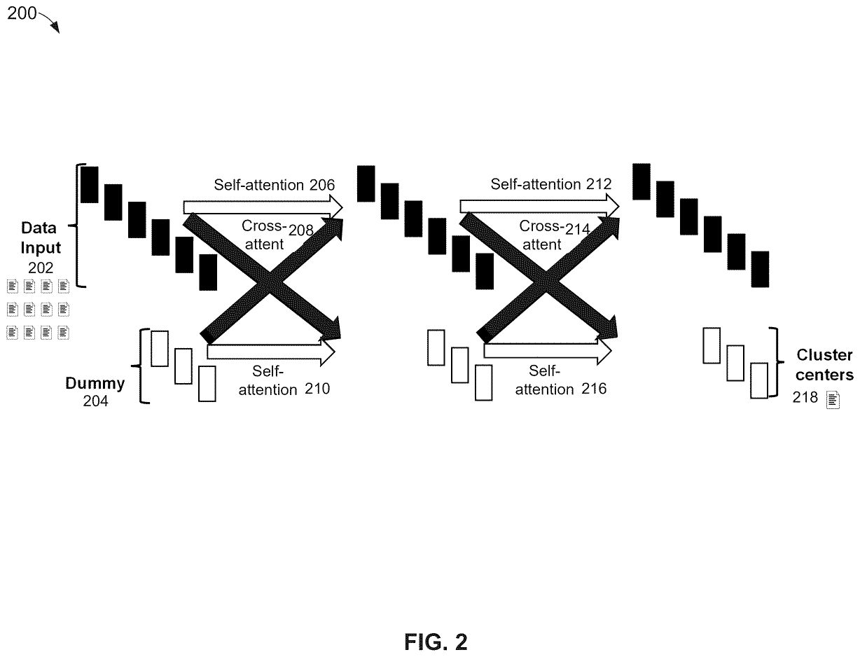

FIG. 2 shows a diagram 200 of clustering using a transformer-based architecture that utilizes self-attention and cross-attention, according to some embodiments. The data input 202 may be a set of data points, and self-attention may be set up with dummy data 204. A first transformer layer may utilize self-attention 206 with the data input 202 and self-attention 210 with the dummy data 204. The first transformer layer may utilize cross-attention 208 between the data input 202 and the dummy data 204.

The resulting outputs may undergo self-attentions 212 and 216 and cross-attention 214 of a second transformer layer. After the multiple transformer layers, the transformer-based architecture may output cluster centers 218 that Lloyd's algorithm would have produced, as well as the corresponding cluster assignments for the data points. The transformer-based architecture enables a differentiable discrete clustering method that can be incorporated into a deep learning pipeline, allowing for end-to-end learning and optimization of the clustering process. The transformer-based design is more efficient and scalable than traditional k-means clustering algorithms, and is able to handle large datasets with high-dimensional feature spaces.

FIG. 3A illustrates a process 300 of an example implementation associated with self-attention in general encoder-decoder transformers and back propagation of discrete clustering to allow discrete clustering in a single forward pass, according to some embodiments. As shown in FIG. 3A, example implementation includes a computer 102 that operates a computer system.

As shown by FIG. 3A, and by reference number 330, the computer system may generate data token embeddings 308 for data points 306 and center token embeddings 312 for cluster centers 310. Token embeddings, also known as token representations, are vectors that represent individual tokens in a sequence. These vectors are learned during training and are used as input to the transformer model. Each token in the sequence is embedded into a vector space, where semantically similar tokens are located close to each other. The computer system may also generate data tokens 314 from the data points 306 and center tokens 318 for the cluster centers 310.

As shown by reference number 335, the computer system may set up queries, keys, and matrices for an encoder-decoder transformer that has multiple layers, such as a first transformer layer 302. This may include an encoder query, key, and value matrices 316 and a decoder query, key, and value matrices 320. As shown by reference number 340, the computer system may set up self-attention and cross-attention mechanisms 322. The transformer may be configured with a weight configuration 304 that mimics a Lloyd's algorithm for clustering data points.

The computer system may set up the encoder-decoder transformer with the data token embeddings 308 and the center tokenizer embeddings 312 using semantics that relate the query-key similarities to position locations of data point assignments. In some aspects, the computer system may encode a query, key, and value matrix to update center token embeddings. The self-attention mechanism may use a query projection matrix that focuses on data of the data token embeddings 308, while the cross-attention mechanism uses a query projection matrix that focuses on labels of the data token embeddings 308. For example, these matrices enable the transformer architecture to selectively attend to specific aspects of the input data (e.g., data points 306).

In some aspects, the self-attention mechanism may use a limiting version of a soft-max operation with a sufficiently low temperature parameter. This allows for more precise control over the clustering process, enabling the model to selectively attend to specific aspects of the input data. Additionally, or alternatively, the soft-max operation may utilize a temperature hyperparameter. For example, the temperature hyperparameter may control the level of sharpness in the soft-max output, allowing for more flexible modeling of the clustering process.

As shown by reference number 345, the computer system may perform a first forward pass of the first transformer layer 302 to obtain updated cluster assignments 324 for the data points 306 and updated cluster centers 326.

The transformer-based architecture enables discrete clustering, the use of a specific attention mechanism to update cluster assignments, and the ability to backpropagate through the entire pipeline enable the computer system to perform clustering in a single forward pass. The transformer-based architecture for clustering enables clustering in a wide range of applications, including data compression, information retrieval, and image processing. For example, the system may also provide discoverability benefits by allowing users to easily understand and interpret the clustering results.

The computer system may extract the final cluster assignments from the data points and determine token embeddings after the transformer layers. For example, the computer system may use the soft-max operation to locate positions to get the cluster assignments.

FIG. 3B illustrates a continuation of process 300 and shows a second transformer layer 356, according to some embodiments. As shown by reference number 350, the computer system may perform a second forward pass. The computer system may use the updated cluster assignments 324 and the updated cluster centers 326 output from the first transformer layer 302 as inputs. The second transformer layer 356 may output final cluster assignments 352 for the data points and final cluster centers 354. As shown by reference number 355, the computer system may extract the final cluster assignments 352 and the final cluster centers 354. As shown by reference number 360, the computer system may output the final cluster assignments 352 and the final cluster centers 354. There may be more than two transformer layers.

FIG. 3C illustrates a continuation of process 300 and shows using the final cluster assignments 352 and the final cluster centers 354 as inputs to a downstream action 370. As shown by reference number 365, the computer system may perform the downstream action 370. The downstream action 370 may include an operation such as image processing, data analysis, speech recognition, or another action involving the clustering of data points.

FIG. 4 illustrates a diagram 400 of using a large language model (LLM) for setting up the clustering. For example, the computer system may use an LLM 402 to generate the token embeddings, or vector representations that will be input with the initial cluster centers into the transformer layers.

In an example, the downstream action may include document selection. The computer system may create an index of documents, where each document is represented by a vector. Each document is converted into a vector with an encoder. The encoded documents are clustered into k clusters, where each document belongs to a single cluster. For any query, the computer system may retrieve the relevant documents. The computer system may encode the query into a vector, find the cluster representative that is most similar to the query vector, and retrieve all of the documents in that cluster. That is, the cluster centers may serve as the codebook, and the cluster assignments may serve as the code (bucket index) for individual data points. Cluster centers can serve as class representatives if performing condensed nearest neighbor classification. If the data is being indexed, the objective may be a combination of the tightness of each index bucket and the balance among the index buckets. If clustering for supervised learning (as in condensed nearest neighbor classifier), the objective may be the supervised classification/regression loss. In other examples, the data may include images or text with a learnable vision model (e.g., convolutional, vision transformers, resnets, recurrent neural network based, state-space-machine based).

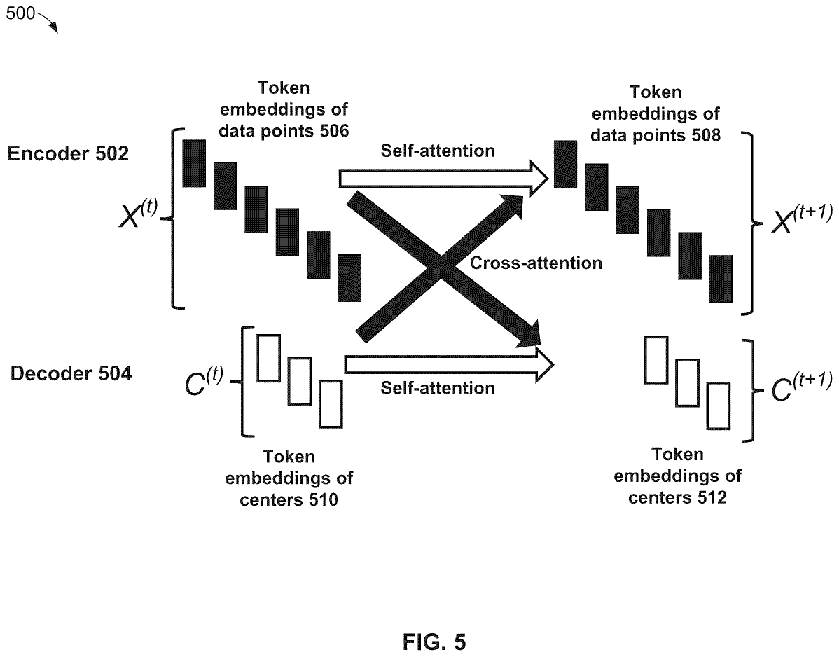

FIG. 5 illustrates a diagram 500 of self-attention and cross-attention, according to some embodiments. Diagram 500 shows that an encoder 502 and a decoder 504 may each perform self-attention individually. However, the encoder and the decoder may perform cross-attention between the encoder and the decoder.

For a single layer of the encoder-decoder transformer, the token embeddings of the data points 506 are on the encoder side, shown by dimension X for current layer t. The token embeddings of the centers 510 are on the decoder side, shown by dimension C for current layer t. The token embeddings of the data points 506 and the token embeddings of the centers 510 are updated using self-attention (SA), cross-attention (CA), and residual connections. As updates happen through residual connections (additions), there may be no explicit reassignment in the transformers.

Diagram 500 shows the resulting token embeddings of the data points 508 (shown by dimension X for next layer t+1) and the resulting token embeddings of the centers 512 (shown by dimension C for next layer t+1). The update of the data points may be represented as X^{(t+1)}=X^{(t)}+SA_{X}(X^{(t)})+CA_{X}(X^{(t)}, C^{(t)}), where SA_{X} is the self-attention of the data points, and CA_{X} is the cross-attention involving the data points and the clusters. The update of the centers may be represented as C^{(t+1)}=C^{(t)}+SA_{C}(C^{(t)})+CA_{C}(C^{(t)}, X^{(t+1)}), where SA_{C} is the self-attention of the clusters, and CA_{C} is the cross-attention involving the clusters and the new data points.

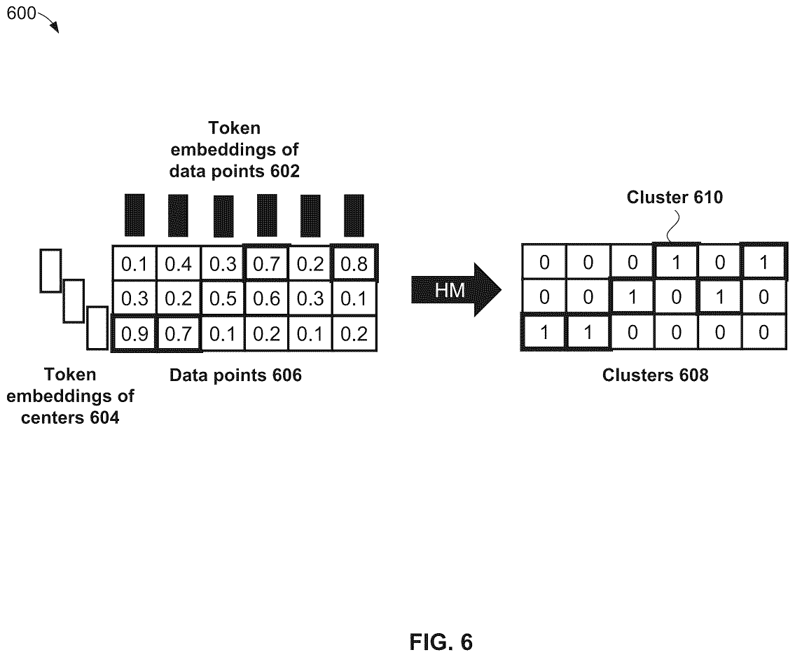

FIG. 6 is a diagram 600 of clustering, according to some embodiments. The computer system may assign clusters to data points given current cluster centers as in a Lloyd's algorithm. The computer system may consider the query-key similarity matrix with the data points as the queries and the cluster centers as the keys. Diagram 600 shows that the computer system may apply averaging hard-max (HM) to the similarity matrix directly to obtain the updated cluster assignments for data points 606. The computer system may use the token embeddings of the data points 602 and the token embeddings of the centers 604 to apply HM in a transformation layer to the matrix of data points 606. The transformation layer may assign the data points 606 to clusters 608. For example, a data point (value of 0.7) may be assigned to cluster 610.

In some implementations, there may be precise transformer parameters—a query projection matrix, a key projection matrix, and a value projection matrix (Q, K, V), such that the computer system is able to obtain the desired behavior with the token embeddings. The query and key projection matrices may focus on the first d dimensions, using only the data part of the embeddings. The value projection matrix may focus on the last k dimensions, using only the label part of the token embeddings. Given these parameters, the cross-attention (with the encoder tokens as queries and the decoder tokens as keys/values) produces the new cluster assignments. In some aspects, there may be separate parts of the token for a data point and for a center. One part stays fixed through the layers while the other part evolves. Different parts may stay fixed (evolve) for the point tokens and center tokens.

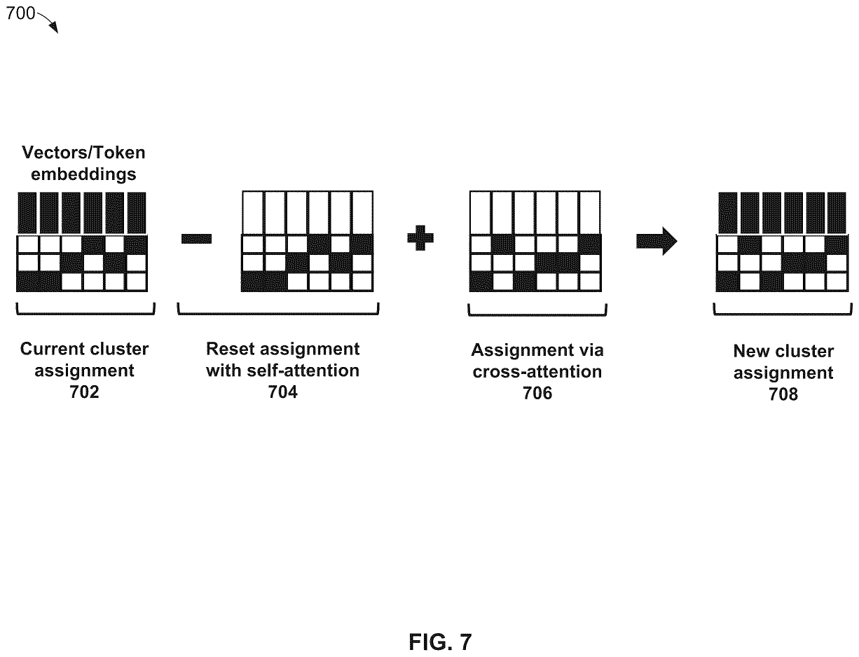

FIG. 7 illustrates a diagram 700 of a reset using self-attention and assignment using cross-attention, according to some embodiments. Diagram 700 shows a current cluster assignment 702 for vectors or token embeddings. In a transformer, the computer system is to update the token embeddings with additive residual connections. However, the previous cross-attention only gives the updated cluster assignments. The current tokens have the current cluster assignment. To perform the update, the computer system may reset the cluster assignments with a residual connection, as shown by reference number 704. This can be achieved via self-attention with specific weights.

As with the cross-attention, the computer system may utilize query and key projection matrices in the self-attention that focus on the data part of the token embeddings. To perform the reset, the computer system may use the value projection matrix that effectively negates the current cluster assignment, and thus, with the residual (additive) connection, resets the current cluster assignments. This reset allows the updating of the new cluster assignments with additive residual connections.

To update the cluster centers, given the current cluster assignments, as in Lloyd's algorithm, the cluster assignment matrix may also be the query-key similarity matrix with the cluster centers as queries and the data points as keys with appropriate (Q, K) matrices. Averaging a hard-max on this similarity matrix creates an effective scaling matrix corresponding to the size of the each of the clusters. Multiplying this matrix with the data points may give the exact cluster centers that Lloyd's algorithm would output. Diagram 700 shows adding the cluster assignment via cross-attention 706 to obtain the new cluster assignment 708.

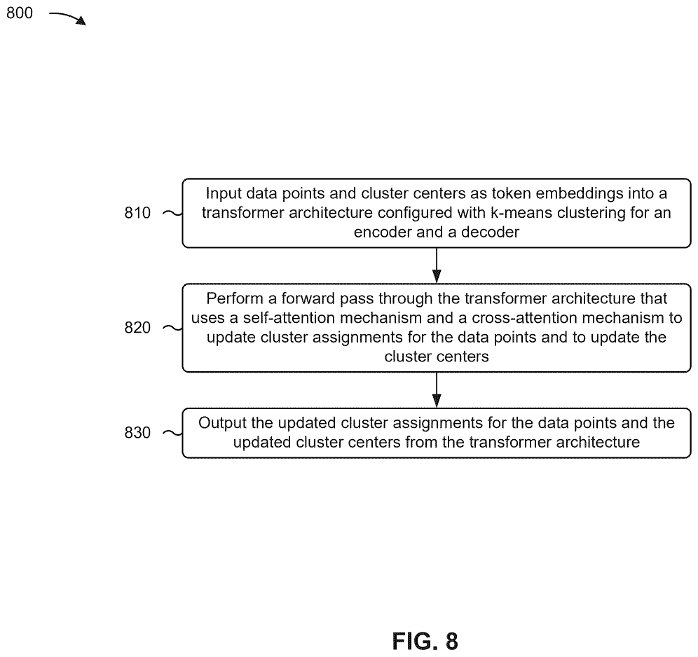

FIG. 8 is a flowchart of an example process 800 associated with transformer-based clustering, according to some embodiments. One or more process blocks of FIG. 8 are performed by a device (e.g., computer 102) and/or by another device or a group of devices separate from or including the device.

As shown in FIG. 8, process 800 includes inputting data points and cluster centers as token embeddings into a transformer architecture configured with k-means clustering for an encoder and a decoder (block 810). For example, the device may input data points and cluster centers as token embeddings into a transformer architecture configured with k-means clustering for an encoder and a decoder, as described above.

As further shown in FIG. 8, process 800 includes performing a forward pass through the transformer architecture that uses a self-attention mechanism and a cross-attention mechanism to update cluster assignments for the data points and to update the cluster centers (block 820). For example, the device may perform a forward pass through the transformer architecture that uses a self-attention mechanism and a cross-attention mechanism to update cluster assignments for the data points and to update the cluster centers, as described above.

As further shown in FIG. 8, process 800 includes outputting the updated cluster assignments for the data points and the updated cluster centers from the transformer architecture (block 830). For example, the device may output the updated cluster assignments for the data points and the updated cluster centers from the transformer architecture, as described above.

Process 800 may include additional aspects, such as any single aspect or any combination of aspects described below and/or in connection with one or more other processes described elsewhere herein.

In a first aspect, the transformer architecture uses a weight configuration to implement Lloyd's algorithm for the k-means clustering in the forward pass.

In a second aspect, alone or in combination with the first aspect, the using of the self-attention and the cross-attention mechanism comprises utilizing a limiting version of a soft-max operation with a sufficiently low temperature parameter.

In a third aspect, alone or in combination with one or more of the first and second aspects, process 800 includes converting the data points into data token embeddings with initial cluster assignments and the cluster centers into center token embeddings.

In a fourth aspect, alone or in combination with one or more of the first through third aspects, the data token embeddings have first dimensions comprising data and last dimensions comprising a current cluster assignment.

In a fifth aspect, alone or in combination with one or more of the first through fourth aspects, the self-attention mechanism uses a query projection matrix that focuses on data of the data token embeddings, and the cross-attention mechanism uses a query projection matrix that focuses on labels of the data token embeddings.

In a sixth aspect, alone or in combination with one or more of the first through fifth aspects, the performing of the forward pass comprises using T layers of the transformer architecture, where T is a quantity of clustering steps.

In a seventh aspect, alone or in combination with one or more of the first through sixth aspects, process 800 includes using the updated cluster assignments and updated cluster centers input for further downstream processing.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

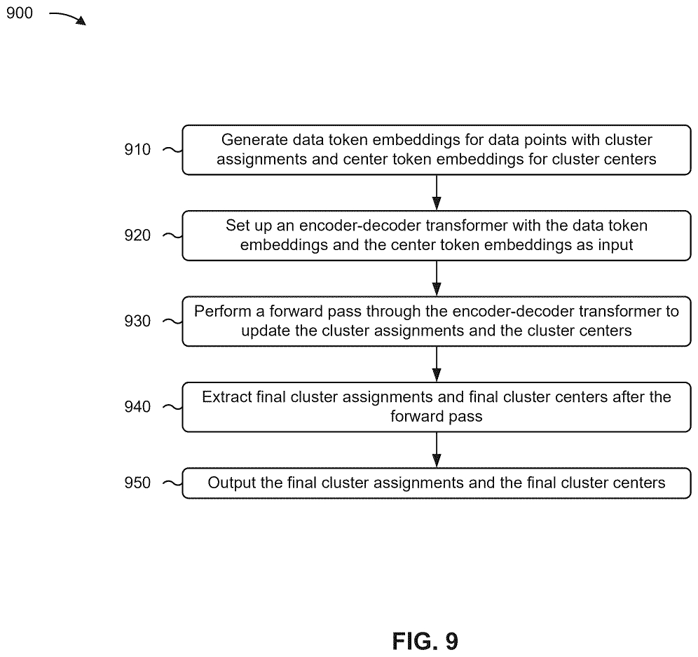

FIG. 9 is a flowchart of an example process 900 associated with transformer-based clustering, according to some embodiments. One or more process blocks of FIG. 9 are performed by a computer system (e.g., computer 102) and/or by another device or a group of devices separate from or including the computer system.

As shown in FIG. 9, process 900 includes generating data token embeddings for data points with cluster assignments and center token embeddings for cluster centers (block 910). For example, the computer system may generate data token embeddings for data points with cluster assignments and center token embeddings for cluster centers, as described above.

As further shown in FIG. 9, process 900 includes setting up an encoder-decoder transformer with the data token embeddings and the center token embeddings as input (block 920). For example, the computer system may set up an encoder-decoder transformer with the data token embeddings and the center token embeddings as input, as described above.

As further shown in FIG. 9, process 900 includes performing a forward pass through the encoder-decoder transformer to update the cluster assignments and the cluster centers (block 930). For example, the computer system may perform a forward pass through the encoder-decoder transformer to update the cluster assignments and the cluster centers, as described above.

As further shown in FIG. 9, process 900 includes extracting final cluster assignments and final cluster centers after the forward pass (block 940). For example, the computer system may extract final cluster assignments and final cluster centers after the forward pass, as described above.

As further shown in FIG. 9, process 900 includes outputting the final cluster assignments and the final cluster centers (block 950). For example, the computer system may output the final cluster assignments and the final cluster centers, as described above.

Process 900 may include additional aspects, such as any single aspect or any combination of aspects described below and/or in connection with one or more other processes described elsewhere herein.

In a first aspect, process 900 includes resetting the cluster assignments using self-attention with specific weights.

In a second aspect, alone or in combination with the first aspect, the data token embeddings comprise a first data part and a first label part, and the center token embeddings comprise a second data part and a second label part.

In a third aspect, alone or in combination with one or more of the first and second aspects, the encoder-decoder transformer performs cross-attention between data points and cluster centers.

In a fourth aspect, alone or in combination with one or more of the first through third aspects, process 900 includes using a row-wise soft-max operation to generate the cluster assignments.

In a fifth aspect, alone or in combination with one or more of the first through fourth aspects, process 900 includes using an averaging hard-max operation to generate the cluster assignments.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

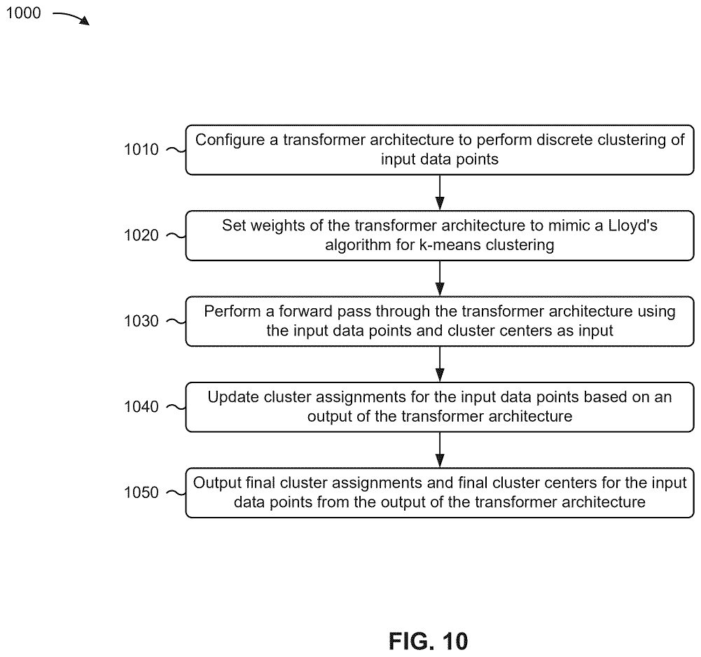

FIG. 10 is a flowchart of an example process 1000 associated with transformer-based clustering, according to some embodiments. One or more process blocks of FIG. 10 are performed by a device (e.g., computer 102) and/or by another device or a group of devices separate from or including the device.

As shown in FIG. 10, process 1000 includes configuring a transformer architecture to perform discrete clustering of input data points setting weights of the transformer architecture to mimic a Lloyd's algorithm for k-means clustering (block 1010). For example, the device may program instructions stored on the one or more computer-readable storage media to perform operations comprising configuring a transformer architecture to perform discrete clustering of input data points setting weights of the transformer architecture to mimic a Lloyd's algorithm for k-means clustering, as described above.

As shown in FIG. 10, process 1000 includes setting weights of the transformer architecture to mimic a Lloyd's algorithm for k-means clustering (block 1020). For example, the device may program instructions stored on the one or more computer-readable storage media to perform operations comprising setting weights of the transformer architecture to mimic a Lloyd's algorithm for k-means clustering.

As shown in FIG. 10, process 1000 includes performing a forward pass through the transformer architecture using the input data points and cluster centers as input (block 1030). For example, the device may program instructions stored on the one or more computer-readable storage media to perform operations comprising performing a forward pass through the transformer architecture using the input data points and cluster centers as input, as descried above.

As shown in FIG. 10, process 1000 includes updating cluster assignments for the input data points based on an output of the transformer architecture (block 1040). For example, the device may program instructions stored on the one or more computer-readable storage media to perform operations comprising updating cluster assignments for the input data points based on an output of the transformer architecture, as described above.

As shown in FIG. 10, process 1000 includes outputting final cluster assignments and final cluster centers for the input data points from the output of the transformer architecture (block 1050). For example, the device may program instructions stored on the one or more computer-readable storage media to perform operations comprising outputting final cluster assignments and final cluster centers for the input data points from the output of the transformer architecture.

Process 1000 may include additional aspects, such as any single aspect or any combination of aspects described below and/or in connection with one or more other processes described elsewhere herein.

In a first aspect, process 1000 includes using cross-attention in the transformer architecture to update the cluster assignments.

In a second aspect, alone or in combination with the first aspect, process 1000 includes utilizing self-attention in the transformer architecture to reset the cluster assignments.

In a third aspect, alone or in combination with one or more of the first and second aspects, process 1000 includes generating token embeddings for the transformer architecture by combining the input data points with a label indicating a current cluster assignment, and utilizing the label to initialize the cluster assignments for the data points.

In a fourth aspect, alone or in combination with one or more of the first through third aspects, process 1000 includes generating token embeddings using a learnable representation network, and utilizing the learnable representation network to generate a vector representation of the input data points.

In a fifth aspect, alone or in combination with one or more of the first through fourth aspects, process 1000 includes generating token embeddings by attaching a one-hot vector to each data point indicating a current cluster assignment, and utilizing the one-hot vector to initialize the cluster assignments for the input data points.

Although FIG. 10 shows example blocks of process 1000, in some implementations, process 1000 includes additional blocks, fewer blocks, different blocks, or differently arranged blocks than those depicted in FIG. 10. Additionally, or alternatively, two or more of the blocks of process 1000 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
inputting data points and cluster centers as token embeddings into a transformer architecture configured with k-means clustering for an encoder and a decoder;
performing a forward pass through the transformer architecture that uses a self-attention mechanism and a cross-attention mechanism to update cluster assignments for the data points and to update the cluster centers; and
outputting the updated cluster assignments for the data points and the updated cluster centers from the transformer architecture.

2. The method of claim 1, wherein the transformer architecture uses a weight configuration to implement Lloyd's algorithm for the k-means clustering in the forward pass.

3. The method of claim 1, wherein the using of the self-attention and the cross-attention mechanism comprises utilizing a limiting version of a soft-max operation with a sufficiently low temperature parameter.

4. The method of claim 1, further comprising converting the data points into data token embeddings with initial cluster assignments and the cluster centers into center token embeddings.

5. The method of claim 4, wherein the data token embeddings have first dimensions comprising data and last dimensions comprising a current cluster assignment.

6. The method of claim 4, wherein the self-attention mechanism uses a query projection matrix that focuses on data of the data token embeddings, and the cross-attention mechanism uses a query projection matrix that focuses on labels of the data token embeddings.

7. The method of claim 1, wherein the performing of the forward pass comprises using T layers of the transformer architecture, wherein T is a quantity of clustering steps.

8. The method of claim 1, further comprising using the updated cluster assignments and updated cluster centers input for further downstream processing.

9. A computer system, comprising:
a processor set;
one or more computer-readable storage media; and
program instructions stored on the one or more computer-readable storage media to cause the processor set to perform operations comprising:
generating data token embeddings for data points with cluster assignments and center token embeddings for cluster centers;
setting up an encoder-decoder transformer with the data token embeddings and the center token embeddings as input;
performing a forward pass through the encoder-decoder transformer to update the cluster assignments and the cluster centers;
extracting final cluster assignments and final cluster centers after the forward pass; and
outputting the final cluster assignments and the final cluster centers.

10. The computer system of claim 9, wherein the operations further comprise resetting the cluster assignments using self-attention with specific weights.

11. The computer system of claim 9, wherein the data token embeddings comprise a first data part and a first label part, and the center token embeddings comprise a second data part and a second label part.

12. The computer system of claim 9, wherein the encoder-decoder transformer is configured to perform cross-attention between the data points and the cluster centers.

13. The computer system of claim 9, wherein the operations further comprise using a row-wise soft-max operation to generate the cluster assignments.

14. The computer system of claim 9, wherein the operations further comprise using an averaging hard-max operation to generate the cluster assignments.

15. A computer program product, comprising:
one or more computer-readable storage media; and
program instructions stored on the one or more computer-readable storage media to perform operations comprising:
configuring a transformer architecture to perform discrete clustering of input data points;
setting weights of the transformer architecture to mimic a Lloyd's algorithm for k-means clustering;
performing a forward pass through the transformer architecture using the input data points and cluster centers as input;
updating cluster assignments for the input data points based on an output of the transformer architecture; and
outputting final cluster assignments and final cluster centers for the input data points from the output of the transformer architecture.

16. The computer program product of claim 15, wherein the operations further comprise using cross-attention in the transformer architecture to update the cluster assignments.

17. The computer program product of claim 15, wherein the operations further comprise utilizing self-attention in the transformer architecture to reset the cluster assignments.

18. The computer program product of claim 15, wherein the operations further comprise generating token embeddings for the transformer architecture by combining the input data points with a label indicating a current cluster assignment, and wherein the instructions further comprise utilizing the label to initialize the cluster assignments for the input data points.

19. The computer program product of claim 15, wherein the operations further comprise:
generating token embeddings using a learnable representation network; and
utilizing the learnable representation network to generate a vector representation of the input data points.

20. The computer program product of claim 15, wherein the operations further comprise:
generating token embeddings by attaching a one-hot vector to each of the input data points indicating a current cluster assignment; and
utilizing the one-hot vector to initialize the cluster assignments for the input data points.
